(19) United States
(12) Patent Application Publication
(10) Pub. No.: US 2011/0086417 A1
(43) Pub. Date: Apr. 14, 2011

(54) Apparatus and Method for Using a Brine Solution to Freeze Biopsy Material

(76) Inventors: Barnet Liberman, New York, NY (US); Mark Sanders, Minneapolis, MN (US)

(21) Appl. No.: 12/993,730

(22) PCT Filed: May 21, 2009
(86) PCT No.: PCT/US09/44879

§ 371 Date: Nov. 19, 2010

Related U.S. Application Data
(62) Division of application No. 61/128,340, filed on May 21, 2008.

(51) Int. Cl. A01N 1/00

(52) U.S. Cl. 435/284.1

(57) ABSTRACT

Apparatus and method for freezing biopsy material. The apparatus includes a container that includes an inner wall and an outer wall defining a space therebeween for receiving a material adapted to withstand a temperature below −20° F. The apparatus further includes a cooling insulating medium that is disposed between the inner wall and the outer wall, a biopsy holding section that is disposed in the cavity and that is configured for holding the biopsy material, and a brine solution that is disposed in the cavity such that the biopsy material held in the biopsy holding section is completed submerged in the brine solution.

### TECHNICAL FIELD

The present invention relates to a method and device that uses a brine solution for freezing biopsy material extracted from a patient.

### BACKGROUND OF THE INVENTION

During the course of medical evaluation, or during other medical procedures, samples of body tissue from a patient are extracted and retained for biopsy. A biopsy is a medical test involving the removal of cells or a sample of tissue for examination. The tissue is generally examined under a microscope by a pathologist and can also be analyzed chemically, for example, using PCR, mass spectroscopy, nucleic acid array, immunological or chromatography techniques. When a tissue sample is extracted, it must be immediately preserved to retain the integrity of the sample as it is transported to a laboratory for testing and analysis. Chemical and low temperature preservations are routinely attempted.

Typical methods for immediately freezing the biopsy sample involve complex and expensive devices, which also require the use and interaction with hazardous and dangerous cooling materials, such as liquid nitrogen, dry ice and/or combinations of flammable solvents. Moreover, such equipment is typically powered by electricity, receiving operating power from line voltage in an operating room. Such equipment is not desirable as it causes unwanted clutter and must also comply with strict standards governing the use of electrical equipment in operating rooms.

Accordingly an apparatus and method are desired for allowing the freezing of biopsy tissue in a convenient and efficient manner while providing transport of the biopsy tissue and without causing undue clutter to an operating room.

### SUMMARY

In one aspect, the invention involves an apparatus for freezing biopsy material. The apparatus includes a container defining a cavity and having a bottom surface, and an inner wall and an outer wall. The outer wall is spaced from the inner wall and the space includes a material that is adapted to withstand a temperature below −20° F. The apparatus further includes a brine solution disposed in the cavity, a cooling medium disposed between the inner wall and the outer wall for maintaining the brine solution at a temperature no higher than −20° F., and a biopsy holding section disposed in the cavity and configured for holding the biopsy material above the bottom surface and below an upper surface of the brine solution such that the biopsy material is completely submerged in the brine solution

In one embodiment, the material of the inner wall and the outer wall include stainless steel or aluminum. In another embodiment, the biopsy holding section includes a mesh section and mesh section holding members. In still another embodiment, the mesh section and the mesh section holding members include stainless steel or aluminum. In yet another embodiment, the mesh section holding members are coupled to the mesh section and the inner wall, and suspend the mesh section in the cavity. In other embodiments, the cooling medium comprises Cold Ice −10° F. “Y” Formula Gel Ice. In still another embodiments, the apparatus includes an insulation material disposed on the outer wall, handles coupled to the outer wall, and a removable double walled cover. In another embodiment, the cover includes an inner wall, an outer wall, a cooling medium disposed between the inner wall and the outer wall, a handle, and releasably latches or couples to the container. In yet another embodiment, the cover includes a brine solution circulating mechanism configured to circulate the brine solution around the biopsy material disposed in the cavity. In one embodiment, the circulating mechanism includes one or more stirring members, a drive mechanism for driving the stirring members, and a power supply for supplying power to the drive mechanism. In another embodiment, the circulating mechanism includes at least one manually actuated stirring member. In still another embodiment, the one or more stirring members, a drive mechanism for driving the stirring members, and a power supply are replaceable with a manually actuated stirring member. In yet another embodiment, the power supply includes a power switch for enabling or disabling power to the drive mechanism. In another embodiment, the biopsy sample is stored in an aluminum foil packet or a stainless steel tube. In another embodiment, the brine solution includes at least about 0.005% by weight of cruciferous oil, about 0.005% to 0.018% by weight of cruciferous oil, propylene glycol and deionized water, or calcium chloride. In another embodiment, the brine solution includes about 0.01% by weight of rapeseed oil, about 43.18% by weight of water, about 44.06% by weight of propylene glycol, and about 12.75% by weight of calcium chloride.

According to another aspect, the invention involves a method of freezing biopsy material in an operating room. The method includes providing an apparatus as described above, disposing the container in a freezer to freeze the cooling medium, filling the container with the brine solution having a temperature no higher than −20° F., and disposing the biopsy material in the container such that the biopsy material is completely submerged in the brine solution.

According to yet another aspect, the invention involves an apparatus for freezing biopsy material. The apparatus includes a container defining a cavity and having a bottom surface, an inner wall and an outer wall. The outer wall is spaced from the inner wall. The inner wall and the outer wall include a material adapted to withstand a temperature below −20° F. The apparatus further includes a brine solution disposed in the cavity, a cooling medium disposed between the inner wall and the outer wall maintaining the brine solution at a temperature no higher than −20° F., a removable double walled cover configured to seal the cavity, and a biopsy holding section. The biopsy holding section is either coupled to a side of the cover proximate the brine solution, coupled to a stirring member that is coupled to the cover, or acts/functions as the stirring member coupled to the cover. The biopsy holding section is positioned for immersion in the brine solution when the cover is disposed on the container in sealing engagement therewith.

In one embodiment, the biopsy holding section acting as the stirring member coupled to the cover includes a bracket and an aluminum foil packet holding the biopsy material. The bracket holds the aluminum foil packet.

### BRIEF DESCRIPTION OF THE DRAWINGS

In the drawings, like reference characters refer to the same parts throughout the different views. Also, the drawings are not necessarily to scale, emphasis instead generally being placed upon illustrating the principles of the invention.

FIG. 1 is an illustrative cross-sectional diagram of a container which uses a cooled brine solution for preserving a biopsy sample while the sample is transported from an operating or biopsy room to a testing laboratory in accordance with an embodiment of the invention.

FIG. 2A is an illustrative cross-sectional diagram of the container including a cover for the container of FIG. 1.

FIG. 2B is an illustrative cross-sectional diagram of a cover including a biopsy sample holding section coupled to the underside of the cover.

FIG. 3A is an illustrative cross-sectional diagram of the container including a cover with an automatic circulating mechanism.

FIG. 3B is an illustrative cross-sectional diagram of the container including a cover with an automatic circulating mechanism and a biopsy sample attached to one of the stirring members.

FIG. 3C is an illustrative cross-sectional diagram of the container including a cover with a circulating mechanism with an aluminum foil packet holding a biopsy sample acting as a stirring member

FIG. 3D is an illustrative cross-sectional diagram of the container including a cover with a manual circulating mechanism.

### DETAILED DESCRIPTION

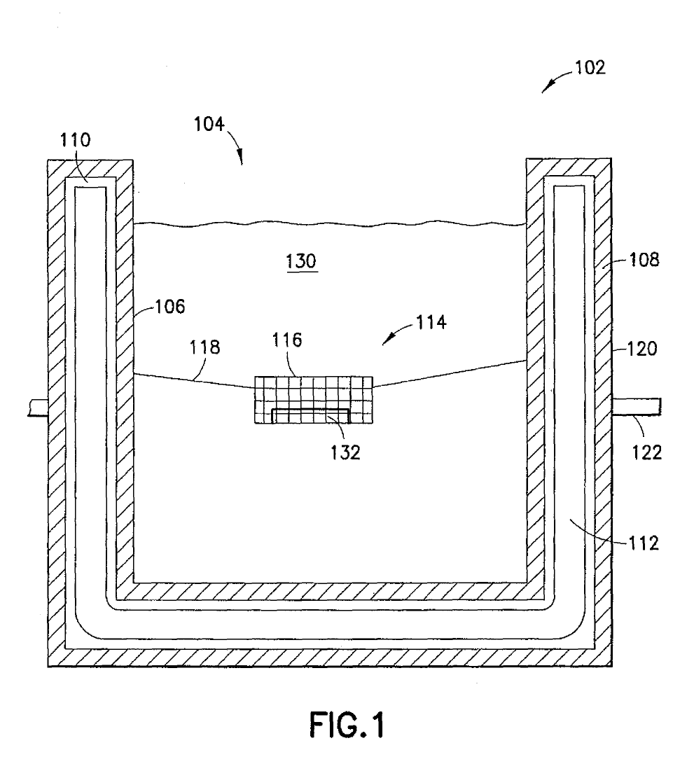

Referring to FIG. 1, a container 102 is formed of a material that is capable of withstanding temperatures below −20° F., such as stainless steel or aluminum, or other medical grade material known in the art. The container 102 is open at one end to define a cavity 104 for holding a reservoir or “bath” of a brine solution 130 and a biopsy sample 132. The container 102 includes an inner wall 106 spaced from an outer wall 108 to define an inner area therebetween for receiving a cooling material or medium 112, such as a gel. An example of a suitable cooling medium is Cold Ice −10° F. “Y” Formula Gel Ice from Cold Ice, Inc. The cooling medium 112 functions to insulate the cavity 104 from the ambient room temperature and maintain the brine solution 130 disposed therein at a temperature no higher than −20° F.

The container 102 further includes a biopsy sample holding section 114 for holding the biopsy sample 132 stationary and suspended below a surface of the brine solution 130, such as in the center of the cavity 104. The biopsy sample holding section 114, in one embodiment, includes a stainless steel or aluminum screen or mesh section 116, such as a basket, and mesh section holding members 118 which may be in the form of arms or rods which connect the basket 116 to the container 102, and suspend the basket 116 in the cavity 104. The biopsy sample holding section 114 allows the brine solution 130 to contact all sides of the biopsy sample 132 when the biopsy sample is in the basket 116 and immersed in the brine solution.

In one embodiment, the biopsy sample, after extraction from the patient using extraction methods known to those skilled in the art, is deposited in an aluminum foil packet, which provides exposure of a greater surface area of the biopsy sample for rapid freezing. In another embodiment, the biopsy sample is left in a stainless steel tube used with a biopsy extraction needle. The stainless steel tube has an inner diameter that is greater than the biopsy extraction needle to facilitate easy removal of the frozen biopsy sample.

In one embodiment, the aluminum foil packet or stainless steel tube is placed in (and later removed from) the biopsy sample holding section 114 using forceps or tongs or similar medical instrument.

In another embodiment, the outer wall 108 is covered with an insulation material 120 that helps to insulate the interior area 110 and the cavity 104 from the ambient room temperature. The material 120 also serves to prevent a user from direct contact with the cold outer wall 108.

In still another embodiment, the container 102 includes handles 122 which further function to protect a user's hands from the freezing effects of the brine solution 130 and which allows the container to be transferred to a testing laboratory where the biopsy sample can be removed for testing. In addition to handles, wheels may be provided to assist in container transport.

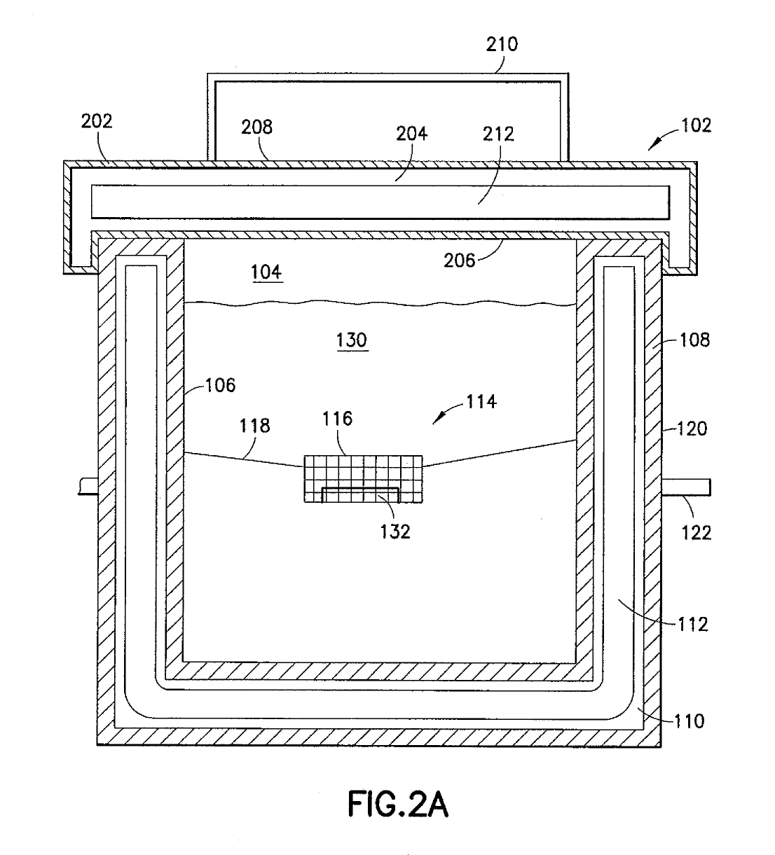

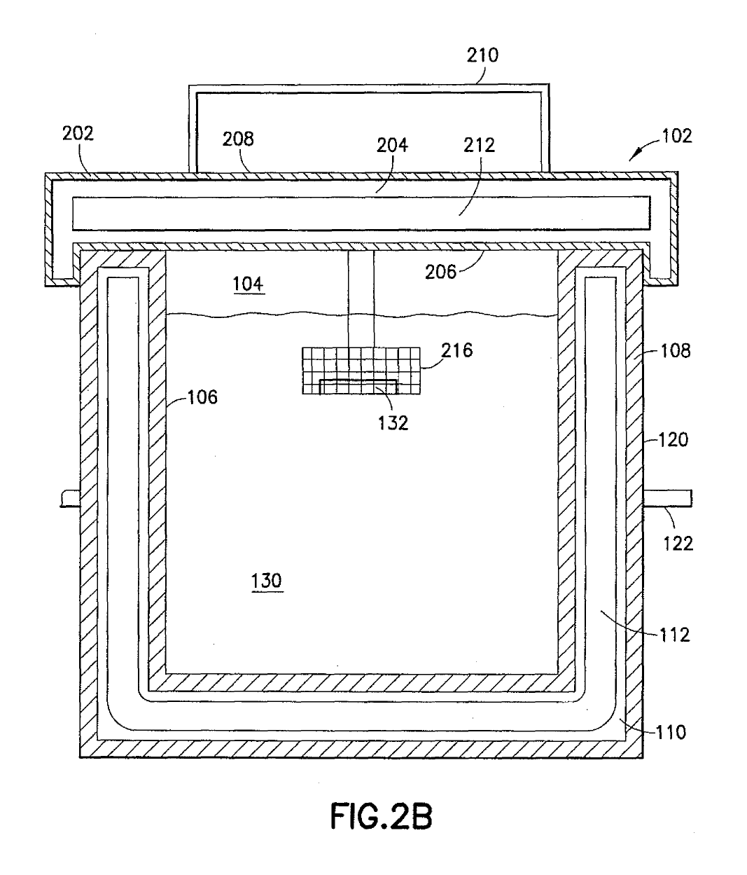

Referring to FIG. 2A, in another embodiment, the container 102 includes a removable double walled cover 202 which includes an inner wall 206 and an outer wall 208 with a cooling medium 212 such as a gel or other material disposed therebetween. In a preferred embodiment medium 212 is the same as medium 112. The cover 202 also includes a handle 210 for easy manipulation of the cover. In still another embodiment, the cover 202 is hingedly connected at one end to the container and includes latches at an opposite end to allow the container to be selectively opened or closed. The latches secure the cover to the container in the closed position and allow for containment of the container contents during container transport.

In another embodiment, as shown in FIG. 2B, the cover includes a mesh section 216 removably attached to the underside of the cover 202. In this embodiment, after the biopsy sample is obtained, the biopsy sample is placed in the mesh section 216 and the cover 202 is placed over the cavity 104 containing the brine solution 130. After the cover 202 is in place, the mesh section 216 and the biopsy sample contained therein, are immersed in the brine solution 130.

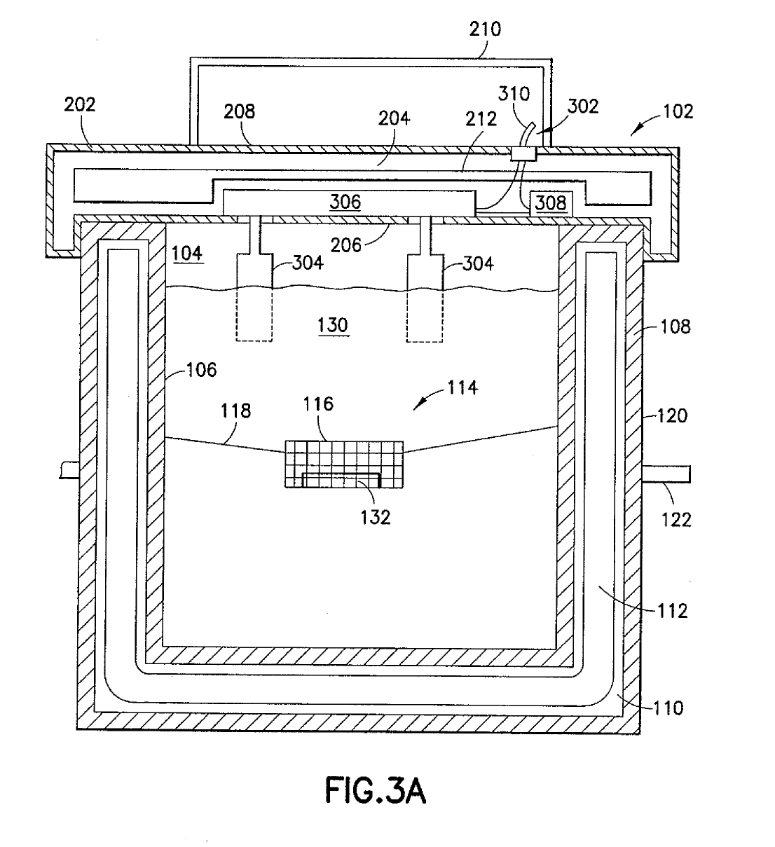

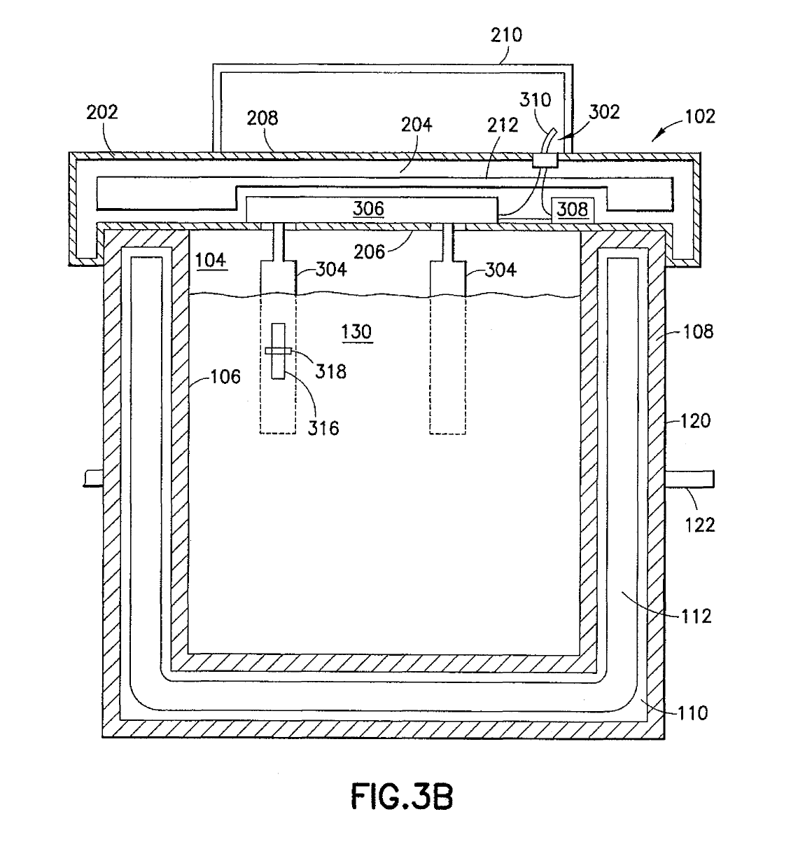

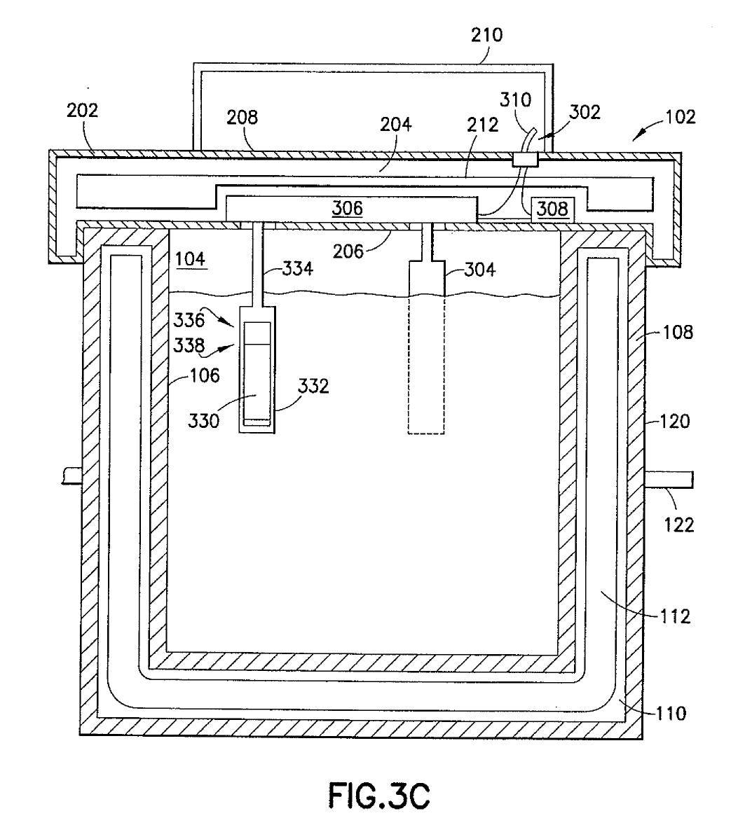

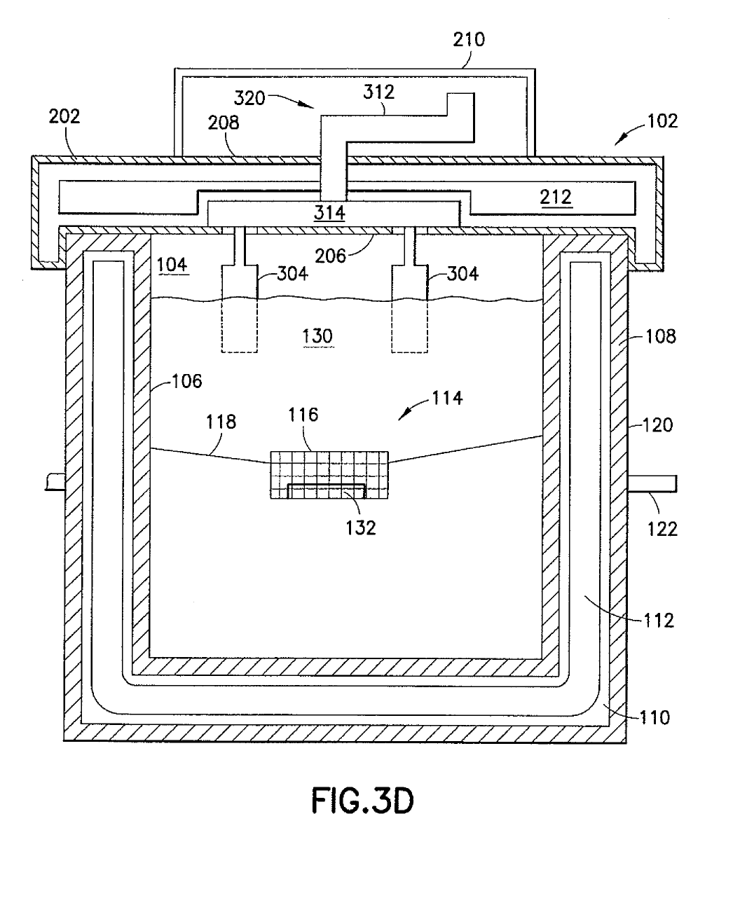

Referring to FIG. 3A, in still another embodiment the cover 202 includes a brine solution circulating mechanism 302. The circulating mechanism 302 includes one or more stirring members 304, a drive mechanism 306 for driving the stirring members 304, and a power supply 308 for supplying power to the drive mechanism 306. The power supply 308 (e.g., batteries) includes a power switch 310 for enabling or disabling power to the drive mechanism 306. The circulation mechanism 302 functions to circulate the brine solution 130 around the biopsy sample suspended in the cavity 104 to provide a uniform temperature of the brine. The power switch 310 can be manually operated or can be in the form of a position switch mounted on one of the cover or container and activated when the cover is in its closed position to operate the circulation mechanism.

Referring to FIG. 3B, in yet another embodiment the biopsy sample is shown contained in an aluminum foil packet 316 which is attached to one of the stirring members 304 by a bracket 318. As the stirring member 304 moves, the biopsy sample is moved through the brine solution 130 thereby allowing the brine solution 130 to circulate around the biopsy sample. It will be appreciated that in the embodiment of FIG. 3B the biopsy holding section 114 will not be required and, for at least this reason, is desired to be detachable and removable from the container.

Referring to FIG. 3C, in another embodiment, a biopsy holding section 336 acting as a stirring member 338 coupled to the cover 202 is shown. The biopsy holding section 336 includes an arm 334, a bracket 332, and an aluminum foil packet 330, which holds a biopsy sample. The bracket 332 holds the aluminum foil packet 330 at the foil packet's edges. The bracket 332 is also coupled to the arm 334. As the stirring member 338 moves in the brine solution 130, the aluminum foil packet 330 holding the biopsy sample is also moved through the brine solution, thereby allowing the brine solution to circulate around the aluminum foil packet 330 holding the biopsy sample.

Referring to FIG. 3D, in another embodiment the cover 202 includes a manual brine solution circulating mechanism 320. The circulating mechanism 320 includes stirring members 304, a gear assembly 314, and an actuator such as a handle 312. In operation, after the cover 202 closes the container 102, a lab technician activates the actuator 312 which in turn engages gears in the gear assembly 314, which cause rotation of the stirring members 304. As above, the circulation mechanism 320 functions to circulate the brine solution 130 around the biopsy sample suspended in the cavity 104 to provide a uniform temperature of the brine solution.

This manually actuated embodiment is particularly useful in an operating room because the brine solution could be circulated without requiring that the circulating mechanism meet the strict requirements governing electrical devices in an operating room environment because of the presence of volatile gases.

In use, the container 102 with cover 202 are disposed in a freezer to cool the gel 112, 212. After cooling, the brine solution 130, which has been previously cooled to a temperature of −20° F. or below, is disposed in the cavity 104 and the cover is closed. The gel 112, 212 functions to keep the brine solution at a temperature no higher than −20° F.

It is preferred that the cooled brine-containing container be located in or proximate to an operating room for surgery, or a room where biopsies are performed. After a biopsy sample 132 has been extracted from a patient, and with the cover 202 in an opened position, the biopsy sample 132 is submerged in the brine solution 132 in the cavity 104 and placed in the biopsy sample holding section 114, for example, by placing the biopsy material (i.e., the foil packet or the stainless steel tube) in the basket and placing the basket 116 on the holding section 114. In another embodiment, the basket 116 is fixed to, or on, the holding section 114 and the biopsy sample in the foil packet or the stainless steel tube is placed in the basket 116 using forceps or tongs. Alternately, and a shown in FIG. 3B, the foil packets are mounted directly to the stirring members 304.

The cover 202 is then closed to cover the brine solution, and the circulating mechanism 302 is activated, whereupon the stirring members 304 circulate the brine solution 130 in the container and, as a result, around the biopsy sample 132. Because the container 102 is intended to be portable so that it can be transported, for example, between an operating room and a testing laboratory, it is preferred that if the power supply is used, it operates on battery power. Alternatively, the manual brine circulating mechanism described above can be used. Thereafter, the container 102 may be used to transport the biopsy sample 132 to a laboratory so that the biopsy sample 132 can undergo testing and analysis.

The brine composition can be any composition suitable for freezing an item, such as any of the brine solutions disclosed in U.S. Pat. Nos. 4,601,909; 4,654,217; 4,657,768; 4,689,963; 4,743,343; 4,840,034; 4,840,035; 5,001,047; and 6,248,381, the contents of which are incorporated by reference.

Preferably, the brine comprises at least about 0.005% by weight of cruciferous oil. More preferably, about 0.005% to 0.018% by weight of cruciferous oil such as rapeseed oil may be used. Alternatively, the amount of cruciferous oil may be selected such that a maximum amount of the oil is dissolved in the brine.

The brine composition preferably comprises propylene glycol and water. It is also preferable that the brine composition contains calcium chloride. The water used in the composition is preferably deionized before being added into the brine composition.

In accordance with one embodiment of the present invention, the brine composition in a desired balance comprises about 0.01% by weight of rapeseed oil, about 43.18% by weight of water, about 44.06% by weight of propylene glycol, and about 12.75% by weight of calcium chloride.

In accordance with one embodiment of the present invention, the brine may be cooled to a predetermined temperature of below about −20° F., preferably −30° F. to about −43° F., and more preferably about −38° F. to −40° F.

Variations, modifications, and other implementations of what is described herein may occur to those of ordinary skill in the art without departing from the spirit and scope of the invention. Accordingly, the invention is not to be defined only by the preceding illustrative description.

1. An apparatus for freezing biopsy material, the apparatus comprising:
a container defining a cavity and having a bottom surface, an inner wall and an outer wall, the outer wall spaced from the inner wall, the inner wall and the outer wall comprising a material which can withstand a temperature below −20° F.;
a brine solution disposed in the cavity;
a cooling medium disposed between the inner wall and the outer wall maintaining the brine solution at a temperature no higher than −20° F.;
a removable double walled cover configured to seal the cavity; and
a biopsy holding section acting as a stirring member and coupled to the cover, the biopsy holding section including a retaining member for holding the biopsy material, the biopsy holding section being positioned for immersion in the brine solution when the cover is disposed on the container in sealing engagement therewith.

2. The apparatus of claim 1, wherein the biopsy holding section further comprises an aluminum foil packet holding the biopsy material, and the retaining member includes a bracket configured to hold the aluminum foil packet.

3. The apparatus of claim 1, wherein the material of the inner wall and the outer wall are comprised of stainless steel or aluminum.

4. The apparatus of claim 1, wherein the biopsy holding section comprises stainless steel or aluminum.

5. The apparatus of claim 1, wherein the cooling medium comprises Cold Ice −10° F. “Y” Formula Gel Ice.

6. The apparatus of claim 1, further comprising an insulative material disposed on the outer wall.

7. The apparatus of claim 1, further comprising handles coupled to the outer wall.

8. The apparatus of claim 1, wherein the cover comprises an inner wall, an outer wall, and a cooling medium disposed between the inner wall and the outer wall.

9. The apparatus of claim 1, wherein cover comprises a handle.

10. The apparatus of claim 1, wherein the cover releasably latches or couples to the container.

11. The apparatus of claim 10, wherein the stirring member circulates the brine solution around the biopsy material.

12. The apparatus of claim 1, wherein the cover comprises a drive mechanism for driving the stirring member.

13. The apparatus of claim 12, wherein the cover further comprises a power supply for supplying power to the drive mechanism.

14. The apparatus of claim 12, wherein the drive mechanism is manually operated.

15. The apparatus of claim 1, wherein the brine solution comprises at least about 0.005% by weight of cruciferous oil.

16. The apparatus of claim 1, wherein the brine solution comprises about 0.005% to 0.018% by weight of cruciferous oil.

17. The apparatus of claim 1, wherein the brine solution comprises propylene glycol and deionized water.

18. The apparatus of claim 1, wherein the brine solution comprises calcium chloride.

19. The apparatus of claim 1, wherein the brine solution comprises about 0.01% by weight of rapeseed oil, about 43.18% by weight of water, about 44.06% by weight of propylene glycol, and about 12.75% by weight of calcium chloride.
